(19) United States
(12) Patent Application Publication
(10) Pub. No.: US 2016/0005410 A1
(43) Pub. Date: Jan. 7, 2016

(54) SYSTEM, APPARATUS, AND METHOD FOR AUDIO FINGERPRINTING AND DATABASE SEARCHING FOR AUDIO IDENTIFICATION

(71) Applicant: Serguei Parilov, San Francisco, CA (US)

(72) Inventor: Serguei Parilov, San Francisco, CA (US)

(21) Appl. No.: 14/752,748

(22) Filed: Jun. 26, 2015

Related U.S. Application Data
(60) Provisional application No. 62/021,538, filed on Jul. 7, 2014.

(51) Int. Cl. G10L 19/018

(52) U.S. Cl. CPC G10L 19/018

(57) ABSTRACT

Client device for audio fingerprinting and database searching for audio identification comprises processor; audio fingerprint (“FP”) generator, query FP storage, FP database storage that stores audio FP database, signature generator, searching module, and display device. Audio FP generator receives audio signals recorded by client device, and generate audio FP of the recorded audio signals that is a query FP stored in query FP storage. Signature generator generates a database of signatures from the FP database, and generates a signature of the query FP. Searching module searches the signature of the query FP in the database of signatures, searches the query audio FP in the FP database when a potential match is obtained for the signature of the query FP, and generates a result of the search of the query audio FP. Display device displays the result of the search which may be an advertisement corresponding to query FP. Other embodiments are described.

### CROSS-RELATED REFERENCES

This application claims the benefit pursuant to 35 U.S.C. 119(e) of U.S. Provisional Application No. 62/021538, filed Jul. 7, 2014, which application is specifically incorporated herein, in its entirety, by reference.

### FIELD

Embodiments of the invention relate generally to a system and method for audio fingerprinting and database searching for audio identification.

### BACKGROUND

Currently, a number of consumer electronic devices (or mobile devices) such as portable telecommunications device, smart phones, laptops, and tablet computers are adapted to receive audio signals via microphone ports.

Accordingly, a user may record the audio within his proximity using his mobile device. The audio being recorded will include the speech, music, and other sounds or noises in the user's environment. Some mobile devices via audio recognition applications may identify the music contained in the audio signal for the user. However, these audio recognition applications require that a large static database of music be previously generated and maintained, they cannot be used to identify audio content other than music, and/or they are not sufficiently robust to unpredictable ambient or environmental noise.

### SUMMARY

Generally, the invention relates to a system, apparatus, and method for audio fingerprinting and database searching for audio identification. For instance, system and method may be implemented on a mobile device and a server that are communicatively coupled. The user on his mobile device may record sounds or acoustic signals that are proximate to the mobile device. The recorded sounds or acoustic signals are compared to a database of known audio recordings (e.g., music, TV programs, movies, etc.) and the mobile device identifies the recording from the database that the user is watching or listening. In one embodiment, a user may use his mobile device to identify a program or advertisement that he is listening to on his television or radio.

More specifically, the invention provides a server that generates audio fingerprints of television broadcasts that may be live to generate a dynamic database of fingerprints. The entire database of fingerprints or relevant portions of the database of fingerprints as well as corresponding metadata may be transmitted to user's mobile devices. The mobile devices may also generate an audio fingerprint of, for instance, at least a portion of an advertisement being shown on a given television broadcast. The mobile device may also generate an audio query being a signature of the audio fingerprint of the portion of the advertisement to perform a first stage of matching (or early rejection) with the audio fingerprint database. If the mobile device identifies a potential match during the first stage of matching, the mobile device may perform a second stage of matching using the audio fingerprint of the portion of the advertisement. Once the mobile device identifies the advertisement, the mobile device may generate on the user interface a display that allows the user to purchase the product or service associated with the advertisement.

In other embodiments, the audio query may be a television broadcast show or movie such that once the mobile device identifies the show or movie, the mobile device generates on the user interface a display that includes the identification of the show or movie and any data that is associated therewith (e.g., website, cast list, time of the broadcast, pictures, etc.).

The above summary does not include an exhaustive list of all aspects of the present invention. It is contemplated that the invention includes all systems, apparatuses and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 illustrates a block diagram of a system for audio fingerprinting and database searching for audio identification according to one embodiment of the invention.

FIG. 2 illustrates a block diagram of the details of the consumer electronic device from the system in FIG. 1 for audio fingerprinting and database searching for audio identification according to one embodiment of the invention.

FIG. 3 illustrates a block diagram of the details of the server from the system in FIG. 1 for audio fingerprinting and database searching for audio identification according to one embodiment of the invention.

FIG. 4 illustrates a flow diagram of an example method for audio fingerprinting and database searching for audio identification according to one embodiment of the invention.

FIG. 5 illustrates a flow diagram of an example method for building the audio fingerprint (short code) in Block 401 from FIG. 4 according to one embodiment of the invention.

FIG. 6 illustrates a flow diagram of an example method for building the spectrogram in Block 502 from FIG. 5 according to one embodiment of the invention.

FIG. 7 illustrates a flow diagram of an example method for extracting subspectrograms in Block 503 from FIG. 5 according to one embodiment of the invention.

FIG. 8 illustrates a flow diagram of an example method for performing the first stage matching in Block 402 from FIG. 4 according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

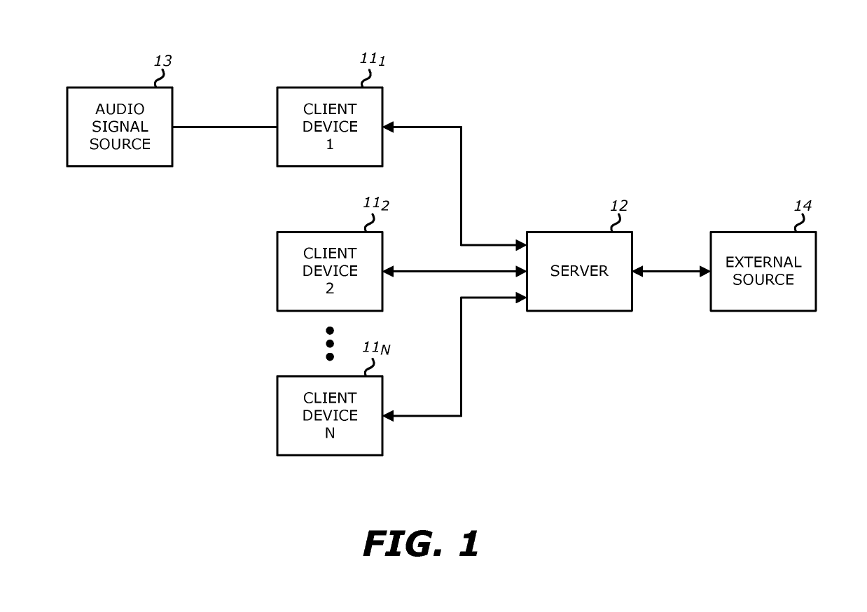

FIG. 1 illustrates a block diagram of a system for audio fingerprinting and database searching for audio identification according to one embodiment of the invention. The networked system 100 may include one or more client devices 11₁-11ₙ (n>1) coupled to a server 12 via a network (not shown). The network may be a cellular mobile phone network (e.g. a Global System for Mobile communications, GSM, network), including current 2G, 3G, 4G, and LTE networks and their associated call and data protocols; and an IEEE 802.11 data network (WiFi or Wireless Local Area Network, WLAN).

The client devices 11₁-11ₙ may be consumer electronic devices (or mobile devices) such as a mobile telephone device, a Smart Phone, a tablet computer, a laptop computer, etc. As shown in FIG. 1, the client devices 11₁-11ₙ may record audio signals from an audio source 13 such as a television, a personal computer, a radio, a music player, etc. The server 12 may be a computer that is may be communicatively coupled to an external source 14 via the network (e.g., Internet). The external source 14 transmits to the server 12 broadcast video and audio data (e.g., multimedia data) through, for example, TV cable and FM receivers, for all the channels that the server 12 monitors. The server 12 may also receive metadata corresponding to the multimedia data from the external source 14. The server 12 may also receive metadata from a source that is separate from the external source 14. For instance, the metadata may be received from (1) human operators that watching the television (TV) broadcasts and are inputting the metadata manually, (2) an automated recognition process, (3) an external database such as the TV listings, etc. In one embodiment, the server 12 receives metadata corresponding to the advertisements airing on the monitored channels from the external source 14 or from a different source. The metadata may include information identifying the advertisements being played on a given channel at a given time.

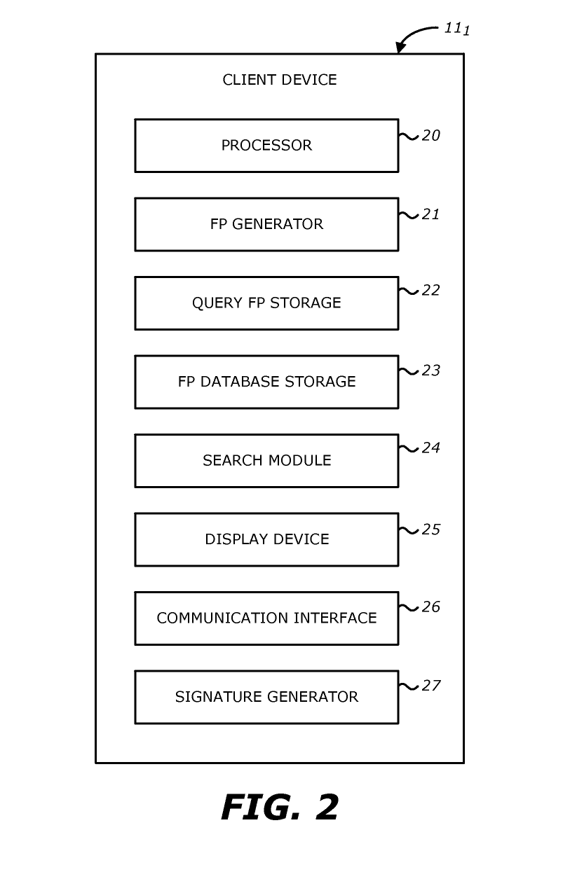

FIG. 2 illustrates a block diagram of the details of the client device 11₁ from the system in FIG. 1 for audio fingerprinting and database searching for audio identification according to one embodiment of the invention. The client device 11₁ includes a processor 20, an audio fingerprint (“FP”) generator 21, a query FP storage 22, a FP database storage 23, a searching module 24, a display device 25, a communication interface 26 and a signature generator 27.

The processor 20 may be a microprocessor, a microcontroller, a digital signal processor, or a central processing unit. The term “processor” may refer to a device having two or more processing units or elements, e.g. a CPU with multiple processing cores, a GPU with parallel processing units. The processor 20 may be used to control the operations of components of the client device 11₁ by executing software instructions or code stored in storage (not illustrated).

For instance, the audio fingerprint (“FP”) generator 21 may be coupled to processor 20. The audio FP generator 21 may receive audio signals that were recorded by the client device 11₁'s microphone (not shown). The recording of the audio signals may be continuous. The audio FP generator 21 may continuously build and generate audio FP of the recorded audio signals, as further described below, which are stored in the query FP storage 22. In one embodiment, the query FP storage 22 is a First-In-First-Out (FIFO) buffer. In one embodiment, the query FP storage 22 is a FIFO buffer that may store 10 to 15 seconds of recorded audio signal.

The client device 11₁ is coupled to the server 12 as shown in FIG. 1. The server 12 may be one of a plurality of servers. The client device 11₁ may select the appropriate server 12 from the plurality of servers based on the quality or price of the connection to the server 12. Once selected, the client device 11₁ may subscribe to the updates from the server 12 by opening a TCP/IP connection to the server, for instance. The server 12 may transmit updates of audio FP database and associated metadata. For example, every second, the client device 11 may receive the audio FPs for the last second of audio signal that was broadcast on all the TV channels that are monitored by the server 12. Thus, at regular time intervals, the server 12 transmits updates to the audio FP database and metadata to the client device 11₁ which are stored in the FP database storage 23. In another embodiment, the server 12 transmits these updates at irregular time intervals. For instance, the client device 11₁ may request the transmission of the updates from the server 12 whenever the client device 11₁'s processor 30 indicates that an update to the FP database and the metadata is needed. In this embodiment, the client device 11₁ may request that an update be transmitted from the server 12 when the client device 11₁ detects a long period of silence (e.g., no sound recorded). The FP database storage 23 may also be a FIFO buffer. The client device 11₁ thus maintains in the FP database storage 23 the FPs for the last minute, for example, of audio signal, since the FIFO buffer (FP database storage 23) discards the older FPs. It is contemplated that a sufficiently large FIFO buffer is used as FP database storage 23 to compensate for possible delays in transmission.

At regular time intervals, or when the client device 11₁ receives an update to the FP database from the server 12, the processor 20 causes the searching module 24 to perform a search of the query audio FP that is stored in the query FP storage 22 in the FP database that is stored in the FP database storage 23. In one embodiment, the signature generator 27 may generate a database of signatures from the FP database 23, generate a signature of the query FP, and the searching module may perform the search of the signature of the query FP in the database of signatures. In this embodiment, if a potential match is found using the signatures, the searching module 24 performs a search of the query FP in the relevant portions of the FP database where a potential match was identified using the signature of the query FP and the database of signatures. The searching algorithm is described in further detail below. In one embodiment, the searching module 24 identifies for instance the television (TV) channel being watched and further identifies the specific advertisement that corresponds to the generated audio FP using the metadata as well as the time and position in the received FP database (FIFO) storage 23. The searching module 24 may also use the metadata to obtain the data associated with the specific advertisement from an external web-server (e.g., images, information, contact information, etc.).

The processor 20 may cause the display device 25 of the client device 11₁ to display the result of the search. For instance, the display device 25 which may be a touch screen user interface may display the identification of the specific advertisement that corresponds to the generated audio FP (or query FP). The display device 25 may also be caused to display the data associated with the specific advertisement. For instance, the display device 25 may display a virtual button or link that allows the user to be directed to the advertisement's associated website. The virtual button or link may also allow the user to purchase the product or services associated with the advertisement. The client device 11₁ also includes a communication interface 26 that allows for communication with the server 12, the external web-servers, the network, etc. In one embodiment, instead of or in addition to being displayed by the client device, the result of the search may be stored in a storage on the client device, the server or an external system, or may be transmitted to an external system for further processing, storage or display.

In one embodiment, rather than receiving updates of the entire FP database from the server 12, the client device 11₁ may receive only relevant portions of the FP database to be updated in the FP database storage 23. In this embodiment, the query FP storage 22 is a larger FIFO buffer of generated FPs. Via the communication interface 26, the client device 11₁ may transmit the contents of the query FP storage 22 or a signature of the query FP that is stored in the query FP storage 22. The client device 11₁ makes this transmittal either at regular intervals of time or when a search (or identification) of the query FP is desired (e.g., when the user of the client device 11₁ records and submits the audio signals). In this embodiment, the client device 11₁ further includes a signature generator 27 to generate the signature of the query FP as described below. In this embodiment, the server 12 performs a search to determine the relevant portions of FP database to transmit (e.g., the portions of the FP database that contain potential matches to the query FP). The client device 11₁ stores the relevant portions of FP database in the FP database storage 23 and the processor 20 causes the searching module 24 to perform the search of the query audio FP in the FP database.

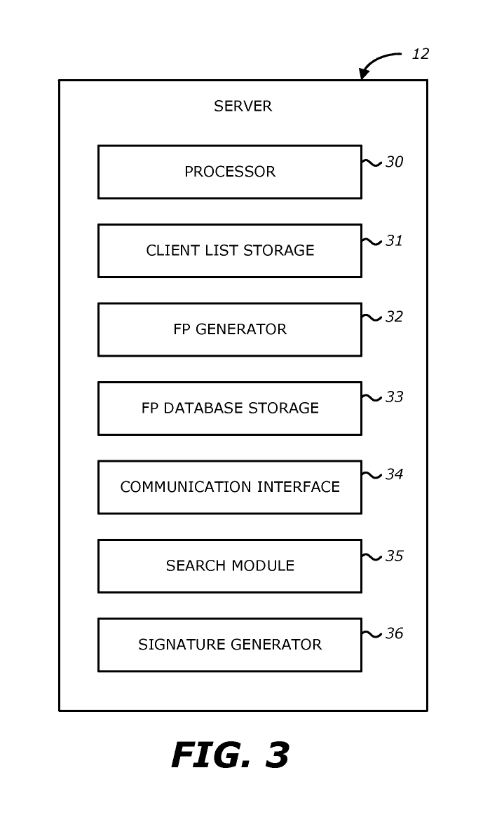

FIG. 3 illustrates a block diagram of the details of the server 12 from the system in FIG. 1 for audio fingerprinting and database searching for audio identification according to one embodiment of the invention. The server 12 includes a processor 30, a client list storage 31, an FP generator 32, a generated FP storage 33, a communication interface 34, a searching module 35, a signature generator 36.

The client list storage 31 may be a memory storage that includes the list of client devices 11₁-11ₙ that are subscribed to receive updates to their respective FP database storages 23 from the server 12.

Similar to the processor 20 in the client device 11₁, the processor 30 may be a microprocessor, a microcontroller, a digital signal processor, or a central processing unit. The term “processor” may refer to a device having two or more processing units or elements, e.g. a CPU with multiple processing cores, a GPU with parallel processing units. The processor 30 may be used to control the operations of components of the server 12 by executing software instructions or code stored in storage (not illustrated).

For instance, the audio FP generator 32 may be coupled to processor 30. The audio FP generator 32 receives broadcast signals (e.g., audio, video, and multimedia) for all the channels that the server 12 monitors. The server 12 may receive the broadcast signals via the communication interface 34 through TV cable, FM receivers, wired or wireless Internet networks, etc. The audio FP generator 32 may continuously build and generate audio FP of the broadcast signals, as further described below, which are stored in the FP database storage 33. In some embodiments, the audio FP generator 32 concatenates the generated audio FPs to generate the FP database that is stored in the FP database storage 33. Via the communication interface 34, the server 12 also receives metadata associated with the broadcast signals from an external source 14 or other external web-servers. The metadata may also be stored in the FP database 33. Similar to the FP database 23, the FP database 33 may be a relatively large FIFO buffer that stores, for example, the last minute (e.g., one minute) of FPs for the broadcast signals. The server 12 may transmit via the communication interface 34 the contents of the FP database 23 to the clients that are identified in the client list storage 31 as updates of audio FP database and associated metadata.

In the embodiment where the client device 11₁ only receives the relevant portions of the FP database to be updated in the client device 11₁'s FP database storage 23 as discussed above, the server 12 receives via the communication interface 34 either the query FP or a signature of the query FP. If a query FP is received, the signature generator 36 of the server 12 generates the signature of the query FP as described below. The signature of the query FP is received by the searching module 35 of the server 12, which performs a search to determine the relevant portions of FP database to transmit (e.g., the portions of the FP database that contain potential matches to the query FP). In this embodiment, as further described below, the signature generator 36 may also generate a database of signatures from the FP database and perform the search of the signature of the query FP in the database of signatures.

Moreover, the following embodiments of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

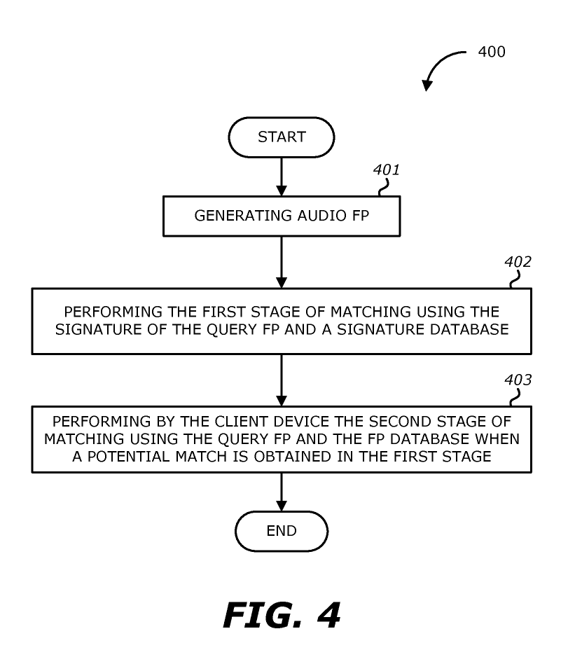

FIG. 4 illustrates a flow diagram of an example method for audio fingerprinting and database searching for audio identification according to one embodiment of the invention.

Method 400 starts with generating audio FP by the client device and by the server (Block 401). In some embodiments, the server may further generate audio FP database by concatenating the generated audio FPs. At Block 402, the first stage of matching is performed using the signature of the query FP and a signature database. The first stage of matching may be performed by the client device or by the server. At Block 403, the client device performs the second stage of matching using the query FP and the FP database when a potential match is obtained in the first stage at Block 402.

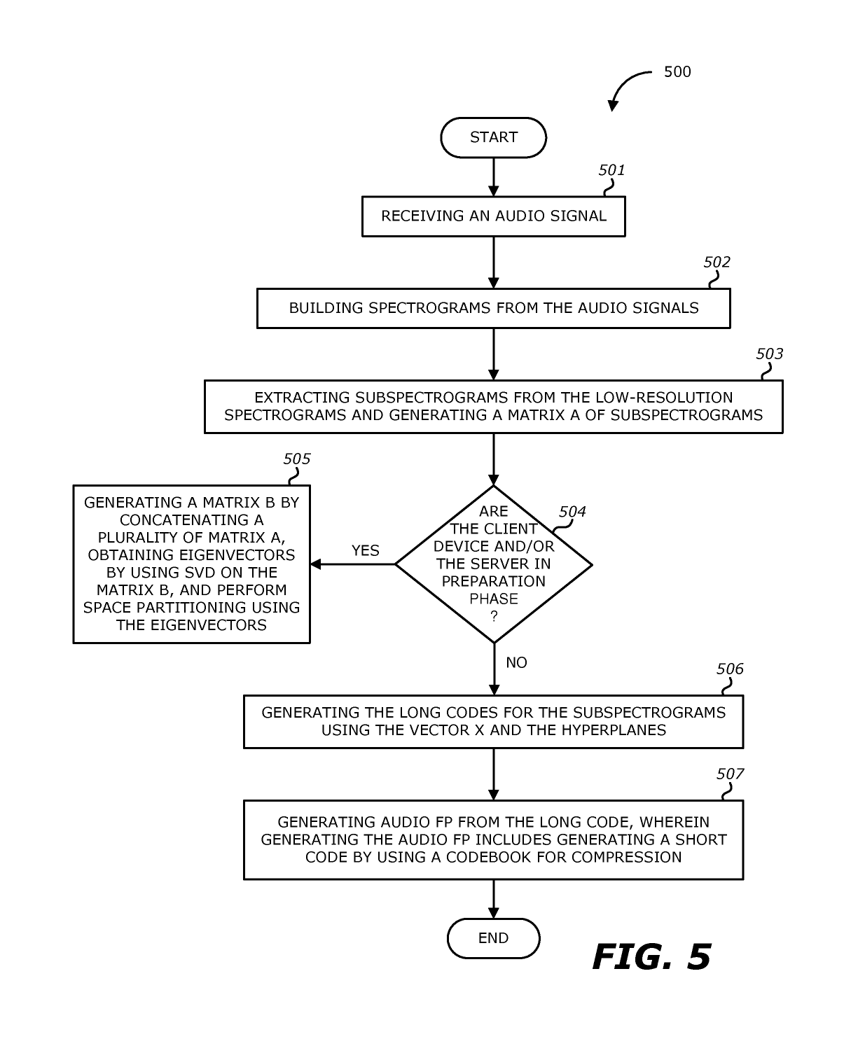

FIG. 5 illustrates a flow diagram of an example method for building the audio fingerprint (short code) in Block 401 from FIG. 4 according to one embodiment of the invention. The method starts at Block 501 with receiving an audio signal. The audio signal may be converted to 8000 Hz, 16-bit mono Pulse Code Modulation (PCM). The audio signal received by the server is a broadcast signal for all the channels that the server monitors. The broadcast signal may be received from an external source. The audio signal received by the client device is the query signal. The user may record the query signal that includes the sounds (including noise) that are proximate to the user using the microphone on his client device. The query signal may include the audio from an advertisement included in a TV broadcast being heard and viewed by the user. At Block 502, the client device and the server build spectrograms from the audio signals that are respectively received.

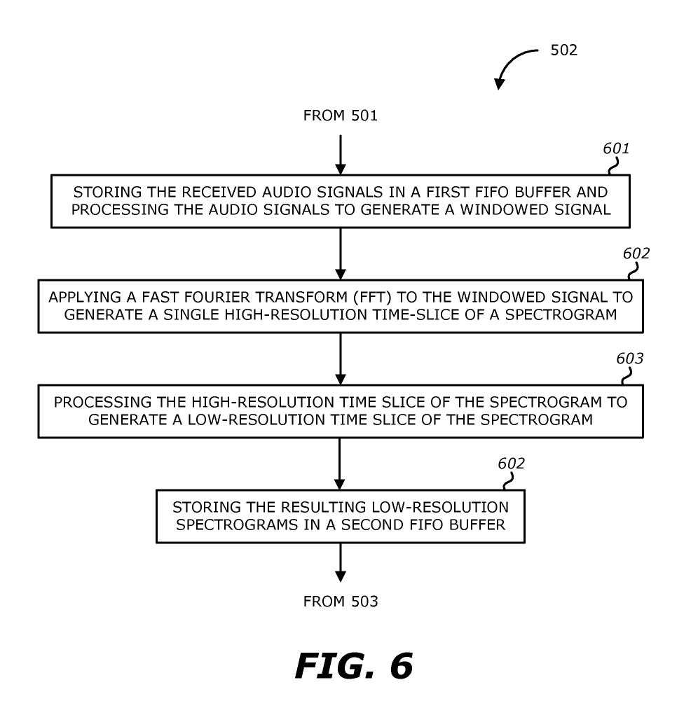

Referring to FIG. 6, a flow diagram illustrates an example method for building the spectrogram in Block 502 from FIG. 5 according to one embodiment of the invention. This method may be used for both offline learning and online recognition. Referring back to FIGS. 2 and 3, the method in FIG. 6 may be implemented by the FP generator 21 of the client device and by the FP generator 32 of the server. As further described below, the FP generator 21 and 32 may include elements such as FIFO buffers. Both the FP generator 21 and 32 may perform the steps described in the method 600. At Block 601, the received audio signals are stored in a first FIFO buffer. In one embodiment, the first FIFO buffer holds 8192 audio samples. In one embodiment, the sampling rate is 8000 Hz. Also at Block 601, at a pre-determined time interval (e.g., every 22 ms), the entire contents of the first FIFO buffer are copied and a Hann windowing function is applied to the copy of the contents of the first FIFO buffer. At Block 602, a Fast Fourier Transform (FFT) is applied to the windowed signal to generate a single high-resolution time-slice of a spectrogram. In one embodiment, this slice includes 4096 frequency bins including the signal power at each frequency. In one embodiment, the window hop, which is the interval between successive FFTs, is 22 ms. This window hop size minimizes the misalignment between the sampling of the signals in the database and the sampling of the query signal. In one embodiment, the FFT window size is 1 second (s). This FFT window size results in averaging the audio signal over longer periods of time such that the fingerprints are more robust and further, the FFT window size results in more noise resistance.

At Block 603, the high-resolution time slice of the spectrogram is processed to generate a low-resolution time slice of the spectrogram. The processing in Block 603 includes discarding the data in the bins of the high-resolution spectrogram that fall outside the desired frequency range (e.g., 300-2000 Hz). The processing in Block 603 further includes partitioning the remaining data in the desired range into a number of bands (e.g., 35 bands) linearly spaced on the MEL scale. As a result of the linear spacing on MEL scale, the bands are logarithmically spaced on the frequency scale in Hz. The processing in Block 603 further includes summing the signal power within each of the bands (e.g., 35 bands) and placing the result in the corresponding bin of the low-resolution spectrogram splice (e.g., 35-bin low-resolution spectrogram slice). At Block 604, the resulting low-resolution spectrograms are stored in a second FIFO buffer. The second FIFO buffer may be a 35×7 matrix of real values and holds the last 7 low-resolution spectrograms, with 35 frequency bins in each spectrogram. Accordingly, in this embodiment, every 22 ms, the method 502 calculates the power of approximately is of audio signal in 35 different frequency bands and keeps the last 7 spectrograms.

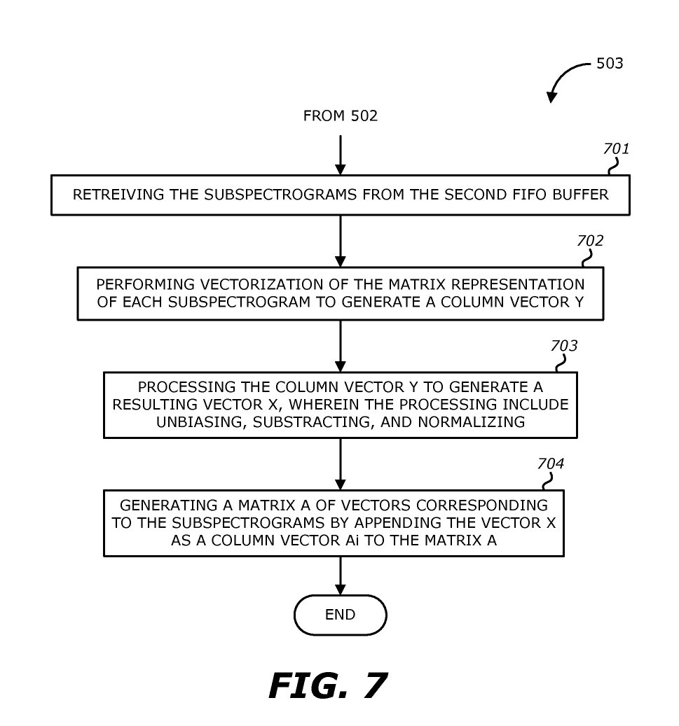

Referring back to FIG. 5, at Block 503, a subspectrogram is extracted from the low-resolution spectrograms that are generated in Block 502 and a matrix of subspectrograms is generated. FIG. 7 illustrates a flow diagram of an example method for extracting subspectrograms in Block 503 from FIG. 5 according to one embodiment of the invention. The method in FIG. 7 may be implemented by the FP generator 21 of the client device in FIG. 2 and by the FP generator 32 of the server in FIG. 3. In one embodiment, each time the second FIFO buffer is updated (e.g., every 22 ms), the method in FIG. 7 is performed. At Block 701, the subspectrograms are retrieved from the second FIFO buffer. The subspectrograms may include the overlapping chunks that are 7 slices wide and 3 bins tall of the second FIFO buffer. In this embodiment, with 35 rows of data in the second FIFO buffer, there will be 32 subspectograms. At Block 702, vectorization of the matrix representation of each subspectrogram is performed to generate a column vector y. The column vector y may be a 21 dimensional column vector. At Block 703, column vector y is further processed to generate a resulting vector x. The processing in Block 703 may include unbiasing the data in vector y, calculating the mean value of the elements of vector y and subtracting this mean from all the elements of vector y, and normalizing the vector by scaling it so that its length equals to 1. The resulting vector x is thus generated. In some embodiments, the normalization is not necessary. At Block 704, a matrix A of vectors corresponding to the subspectrograms is generated by appending the vector x as a column vector aᵢ to the matrix A. In one embodiment, since every time the second FIFO buffer is updated the method in FIG. 7 is performed, 32 columns corresponding to the 32 3×7 subspectrograms are added to matrix A. In one embodiment, matrix A has 21 rows, which is the dimensionality of the subspectrograms, and 32 columns, which is the number of subspectrograms that are extracted from the FIFO buffer.

Referring back to FIG. 5, at Block 504, it is determined whether the client device and/or the server are in preparation (or development) phase. If so, at Block 505, a matrix B is generated by concatenating a plurality of matrix A generated at Block 503. In the preparation phase, a matrix A is being generated at a predetermined time interval (e.g., every 22 ms). At Block 505, the concatenation may include concatenating the matrices A side-by-side to generate the large matrix B (e.g., B=[A₀, A₁, . . . , A_{N}]). The number of columns in matrix B depends on the length of the audio signal being processed. In one embodiment, the number of columns in matrix B may be approximated as (32× signal length/22 ms), where 32 is the number of columns in a single matrix A, and the signal length is the length of the input audio signal in milliseconds (ms). At Block 505, a Principal Component Analysis (PCA) is performed on the matrix B. Specifically, using a Singular Value Decomposition (SVD), the matrix B is decomposed to obtain the four (4) eigenvectors that are associated with the largest singular values. Thus, the 4 eigenvectors are real values. With regards to the PCA, it is noted that the vector x generated at Block 703 in FIG. 7, and the eigenvectors generated may be 21-dimensional vectors, which reside in 21-D space. At Block 505, the eigenvectors are used to perform space partitioning. For instance, each of the eigenvectors is interpreted as a normal vectors to hyperplanes in the 21-D space. Since the 4 eigenvectors are generated and kept in Block 505, the space of the subspectrograms is partitioned into 16 regions. Each subspectrogram necessarily falls into one of these regions. In one embodiment, given any spectrogram vector x, the half-space, positive or negative, in which it falls with respect to any hyperplane may be determined by calculating the dot product of vector x and vector u, where vector u is the normal to the hyperplane (or the eigenvector), and taking the sign of the result. If the sign is non-negative, vector x falls into the positive half-space, otherwise, it falls into the negative half-space. While the space is partitioned into regions with hyperplanes and eigenvectors, it is contemplated that other space partitioning may be used such as random planes and projections. Voronois cells with a form of clustering, etc. Further, in order to determine the similarity between the subspectrograms, other measures may be used such as the Euclidean L2 distance between subspectrograms, the L1 distance, Pearson's correlation coefficient (cosine similarity), rank correlation, and other measures. Once the processing in Block 505 is completed, the method proceeds to Block 506.

If at Block 504, it is determined that the client device and/or the server are not in preparation phase, the method also proceeds to Block 506. At Block 506, the long codes for the subspectrograms are generated using the vector x (that are stored in the matrix A from Block 503) and the hyperplanes. In one embodiment, the long code is the index C of the region into which the vector x falls. In one embodiment, the long code is 4-bits long. In that embodiment, 32 long codes are output every 22 ms since the second FIFO buffer is updated every 22 ms. The long codes provide a form of similarity measure between the subspectrograms. Given two long codes for two subspectrograms, the number of different bits, a.k.a. the Hamming distance, between the two long codes is the number of subspaces on which the subspectrograms disagree or do not match. In the embodiment where the space is partitioned with hyperplanes induced by eigenvectors, the Hamming distance between the long codes approximates the Euclidean distance between subspectrograms (e.g., the distance between two vectors in 21-D space). In one embodiment, the long codes result in 32 subspectograms with 4 bits per code, which results in 128 bits per 22 ms of audio signal.

At Block 507, the audio FP is generated from the long codes. First, to generate the audio FP includes generating a short code by using a codebook for compression. The codebook is a look-up table that includes an entry for a short code that corresponds to each long code. According to one embodiment, 16 entries of short codes, one for each of the 16 different regions in partitioned space. In one embodiment, the codebook is a 16-bit integer value codebook in which the bit positions correspond to long codes and the bit values correspond to short codes. This embodiment of the codebook allows for remapping of the long and short codes. In one embodiment, the short code is 1 bit in length while the long code is 4 bits in length. For every predetermined time interval (e.g., 22 ms), 32 long codes are received and for each 4-bit long code, a 1-bit short code is generated. Thus, for every predetermined time interval (e.g., 22 ms), a sequence of 32 bits is generated, where each bit is a short code. At Block 507, all of the short codes that were generated from the audio signal are concatenated to generate one long bit string which is the audio FP. For the client device, the concatenated audio FP represents the query FP whereas for the server, the concatenated audio FP represents the FP database.

A number of methods may be used to construct the codebook that is used to remap the long codes to the short codes. In one embodiment, every combination of mapping between a 4 bit long code and a 1 bit short code may be tested to assess performance on various audio recordings. In this embodiment, the codebook is constructed by selecting the combination that provides proper identification and fulfills various other criteria (e.g., high compressibility of the resulting audio fingerprints).

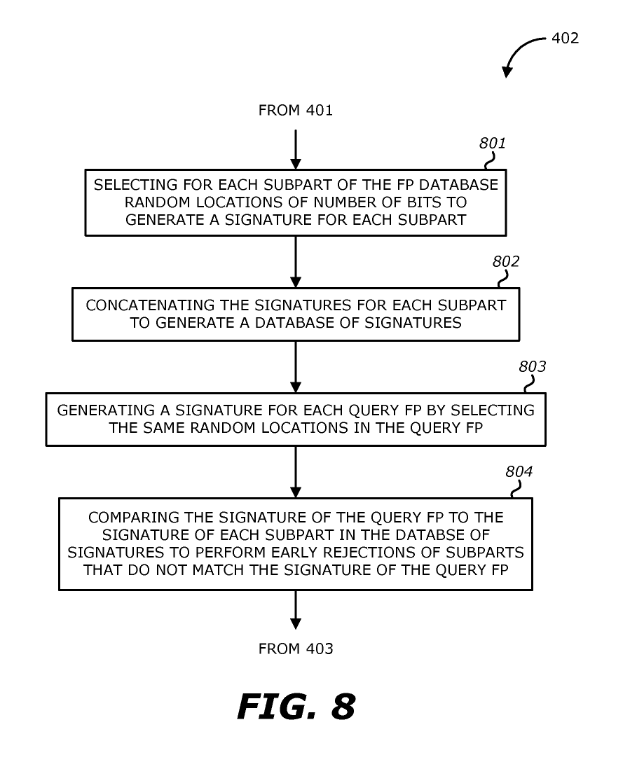

Referring back to FIG. 4, the search module 24 and signature generator 27 in client device (FIG. 2) or the search module 35 and signature generator 36 in the server (FIG. 3) may perform the first stage matching at Block 402. FIG. 8 illustrates a flow diagram of an example method for performing the first stage matching in Block 402 from FIG. 4 according to one embodiment of the invention. At Block 801, for every subpart of the FP database (stored in either FP database storage 23 or FP database storage 33), random locations of number of bits are selected to generate a signature for each subpart. In one embodiment, the subpart of the FP database is a 8192 bit block and a random location of 256 bits are selected. At Block 802, the signatures for each subpart are concatenated to generate a database of signatures. In one embodiment, for each subpart, the same random locations of the number of bits is selected in order to provide of some reuse of data and minimize the memory reads when loading signatures. At Block 803, a signature for each query FP (e.g., 8192 bits) is generated by selecting the same random locations (e.g., the same locations of the 256 bits selected in the subpart) in the query FP. In generating the signature for each query FP, in one embodiment, the step between the blocks of the query FP is equal to 1 32-bit fingerprint (e.g., the step is 32 bits). At Block 804, the signature of the query FP is compared to the signature of each subpart in the database of signatures to perform early rejections of subparts that do not match the signature of the query FP. In comparing the signatures in Block 804, if the difference between the signatures is below a set threshold (e.g., 35%-36%), the signatures in the FP database is determined to be a potential match and the second stage matching in Block 403 of FIG. 4 is to be performed by the client device. In the second stage matching, the client device uses the query FP and searches through the locations in the FP database that correspond to the signatures in the signature database where a potential match was determined in Block 402 of FIG. 4.

In the embodiments described above, the mode of operation considered is a search for a shorter query FP in a longer FP database. However, the mode of operation wherein the query FP is longer than the FP database may also performed using a variation of the embodiments described above. In this embodiment, the query FPs are concatenated into one long bit string rather than the FP database and the FP database is used to search of a match in the long bit string. In other words, the embodiments above may be implemented to address this mode of operation by swapping the query FP with the FP database.

In the description, certain terminology is used to describe features of the invention. For example, in certain situations, the terms “component,” “unit,” “module,” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic. An example of “software” includes executable code in the form of an application, an applet, a routine or even a series of instructions. The software may be stored in any type of machine-readable medium.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. A client device for audio fingerprinting and database searching for audio identification comprising:
a processor;
an audio fingerprint (“FP”) generator coupled to the processor that causes the audio FP generator:
to receive audio signals recorded by the client device, and
to generate audio FP of the recorded audio signals that is a query FP,
a query FP storage to store the query FP;
a FP database storage to store an audio FP database,
a signature generator coupled to the processor that causes the signal generator
to generate a database of signatures from the FP database, and
to generate a signature of the query FP;
a searching module coupled to the processor that causes the searching module
to search the signature of the query FP in the database of signatures,
to search the query audio FP in the FP database when a potential match is obtained for the signature of the query FP, and
to generate a result of the search of the query audio FP; and
a display device to display the result of the search.

2. The client device in claim 1, wherein the query FP storage is a First-In-First-Out (FIFO) buffer and the FP database storage is a FIFO buffer.

3. The client device in claim 1, wherein the searching module to search the query audio FP in the FP database when a potential match is obtained for the signature of the query FP comprises:
searching the query FP in relevant portions of the FP database where a potential match was identified using the signature of the query FP and the database of signatures.

4. The client device in claim 1, wherein the searching module generating a result of the search of the query audio FP comprises:
identifying a television (TV) channel being watched by a user of the client device; and
identifying an advertisement that corresponds the query FP.

5. The client device in claim 4, wherein the display device displays the identified advertisement.

6. The client device in claim 5 wherein the display device displays a virtual button or link (i) to direct a user of the client device to the identified advertisement's associated website or (ii) to allow the user to purchase a product or service associated with the advertisement.

7. The client device in claim 1, further comprising:
a communication interface to receive and transmit communications to a server.

8. The client device in claim 7, wherein the FP database storage receives updates of audio FP database and associated metadata from the server.

9. The client device in claim 8, wherein the updates of audio FP database and associated metadata from the server are received at regular time intervals.

10. The client device in claim 8, wherein the processor transmits via a communication interface a request for the updates from the server at irregular time intervals.

11. The client device in claim 8, wherein the searching module searches the query audio FP in the FP database when updates are received from the server.

12. The client device in claim 7, wherein the processor
transmits contents of the query FP storage or the signature of the query FP that is stored in the query FP storage to the server,
receives from the server relevant portions of a FP database stored in the server, wherein the server transmits the relevant portions of the FP database stored in the server that contain potential matches to the query FP, and
stores in the FP database storage in the client device the relevant portions of FP database stored in the server.

13. The client device in claim 12, wherein the processor transmits the contents of the query FP storage or the signature of the query FP to the server at regular time intervals.

14. The client device in claim 12, wherein the processor transmits the contents of the query FP storage or the signature of the query FP to the server when a search of the query FP is desired.

15. The client device of claim 7, wherein the server comprises:
a processor;
communication interface to receive broadcast signals and metadata associated with the broadcast signals from an external source;
audio fingerprint FP generator to generate audio FP of the broadcast signals, and
FP database storage to store the audio FP of the broadcast signals and the associated metadata,
wherein the server transmits via the communication interface contents of the FP database to the client device.

16. A method for audio fingerprinting and database searching for audio identification comprising:
recording audio signals by a client device;
generating by the client device an audio FP of the recorded audio signals that is a query FP;
storing in a query FP storage of the client device the query FP;
generating by the client device
(i) a database of signatures from a FP database stored in a DP database storage of the client device, and
(ii) a signature of the query FP;
searching by the client device the signature of the query FP in the database of signatures;
searching by the client device the query audio FP in the FP database when a potential match is obtained for the signature of the query FP;
generating a result of the search of the query audio FP; and
displaying by a display device included in the client device the result of the search.

17. The method of claim 16, wherein generating by the client device a database of signatures from the FP database further comprises:
for each subpart of the FP database, random locations of number of bits are selected to generate a signature for each subpart, wherein for each subpart, the same random locations of the number of bits is selected; and
concatenating the signatures for each subpart to generate the database of signatures.

18. The method of claim 17, wherein generating by the client device the signature of the query FP comprises:
generating the signature for the query FP by selecting the same random locations in the query FP.

19. The method of claim 18, wherein searching by the client device the signature of the query FP in the database of signatures comprises:
comparing the signature of the query FP to the signature of each subpart in the database of signatures to perform early rejections of subparts that do not match the signature of the query FP,
wherein the potential match is obtained for the signature of the query FP when the difference between the signature of the query FP and the signature of a matching subpart in the database of signatures is below a set threshold.

20. A computer-readable medium having stored thereon instructions, when executed by a processor, causes a processor to perform a method for audio fingerprinting and database searching for audio identification, the method comprising:
recording audio signals;
generating an audio FP of the recorded audio signals that is a query FP;
storing in a query FP storage the query FP;
generating (i) a database of signatures from a FP database stored in a DP database storage of the client device, and(ii) a signature of the query FP;
searching the signature of the query FP in the database of signatures;
searching the query audio FP in the FP database when a potential match is obtained for the signature of the query FP;
generating a result of the search of the query audio FP; and
displaying by a display device the result of the search.
